(19) United States
(12) Patent Application Publication
(10) Pub. No.: US 2003/0041270 A1
(43) Pub. Date: Feb. 27, 2003

(54) Intelligent identifying method

(76) Inventor: E-Chain Cheng, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/940,201

(22) Filed: Aug. 27, 2001

(51) Int. Cl. H04L 9/32

(52) U.S. Cl. 713/202

(57) ABSTRACT

An intelligent method for allowing access to a computer files includes posing questions to a user. The questions are designed in accordance with the user's information, such as birthday, prior consumption data, and the user's information is designed via different transferring methods to increase the privacy of the question. Therefore, any hackers will have difficulty to find the correct answer to the question.

### BACKCGROUND OF THE INVENTION

1. Field of the Invention

The present invention relates to a method for identifying a person trying to access a computer file, and more particularly to a method that is able to provide an identifying procedure for ensuring a person's identification is valid.

Furthermore, the method is able to avoid unauthorized access to important data, or any similar undesirable actions.

2. Description of Related Art

Credit cards have become internationally accepted as the most convenient method for paying bills and other transactions. With the development of the Internet, commercial and personal information have become widely stored in order to fulfill the easy and rapid exchange of data necessary in the modern world. Therefore the EC (electronic commerce) was born on the Internet for providing a fast and convenient shopping manner.

There are many ways to pay for purchases or services obtained via the Internet, such as credit cards, E-wallets, etc. These ways offer the private information on the connection between a user's terminal device and the web site. A computer hacker can easily steal the private information from the connection, and then use the information to illegally enter or access any web sites or account of the bank. Thus, there are many such problems if a secure protection or identity software or/and hardware etc is not used.

Incalculable losses have already occurred through such computer crimes, but no ideal precautionary measures to solve the problems have been found. The servers of the web sites or of the banks use the SET, SLL, E-Wallet, Digital Certificate etc. encrypting or identifying methods to protect the rights of the authorized people but encrypting and identifying are deductive methods, so the hackers are still able to learn of the real data from the encryption data.

To overcome the shortcomings, the present invention provides a method for identification of a user's identity information to allow the user access to a computer file to mitigate and obviate the aforementioned problems.

### SUMMARY OF THE INVENTION

The objective of the present invention is able to provide an identifying method to check the user's identity information, and furthermore, avoid the illegal user stealing the important information, money, etc.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of an intelligent identifying method in accordance with the present invention;

FIG. 2 is a block diagram of a transaction system architecture system with an intelligent identifying method in accordance with the present invention; and

FIG. 3 is flowchart of the intelligent identifying method in accordance with the present invention.

### DETAILED DESCRIPTION OF THE PREFERRED EMBODIMENT

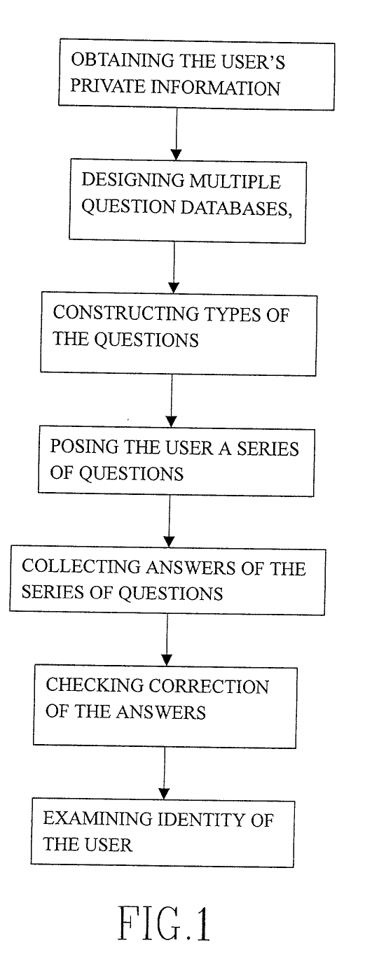

In reference to FIG. 1, the present invention is an identifying method including the following steps:

obtaining the user's private information. Users are able to offer private information in the first use, and then the information is stored.

designing multiple question databases. The private information is designed to respond to many different types of question, such as a direct question, a consumption question, and an inferential question.

constructing types of questions. The questions transferred contain many different quizzing forms to ask the user, and solutions corresponding to the questions are stored in a solution database;

posing the user with a series of questions. A portion of the questions posed to the user are for identification purposes, and the answer of each question is collected from user.

checking correctness of the answers. The answers are checked with the solutions of the solution database for identifying whether the user is valid and legal; and

examining the identity of the user in accordance with the checking result.

In designing a question database step, at least one direct question is designed via a direct method. That is, the user's private information such as address, age, job, blood type, telephone number, birthday etc. data, is directly designed to form the questions, such as, “When or where were you born?” or “How old are you?” questions.

In designing a question database step, at least one consumption question is designed via a consuming method, because the credit card bank or other web sites store up the user's consumption records, the consumption questions are designed in accordance with the prior consumption records. For example, “Did you buy shoes that cost $50 last Monday?” or “Did you order a magazine from AA book store?” questions.

In designing a question database step, the inferential questions are produced by an inferential method. The inferential transfer utilizes a portion of the private information and statistical information to inferentially develop the questions in accordance with being divined by the Eight Diagrams or astrology etc. The correct solutions of the inferential question are calculated by an available software. The question is inferential, so that in the checking correct answer step, a reasonable degree of error is preset before executing the checking correct answer step. For example, the inferential questions are able to be like “Is your personality characteristic peaceful?” or “Does the No. 758 bus drive past the front of your house?” questions.

In the construction of the questions step, the quizzing question types comprise “Multiple-choice”, “Yes Or No”, or “Dialog” question types, such as

“How old are you?”;

“Are you 25 years old?”; and

“Choose the correct number of your age in the following sequence:

(1)25 (2)26 (3)22 (4)none.”

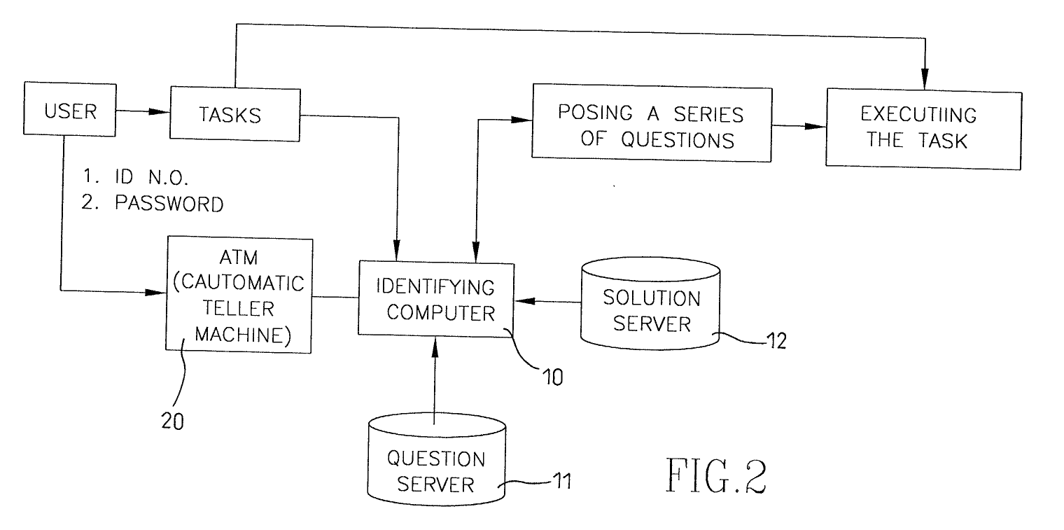

In reference to FIG. 2, a transactions system with the identifying method includes:

an identifying computer (10), which includes a question server (11) having multiple different question database types and a solution server (12) having many solution databases corresponded to the question database (11), gets the series of questions from the different question server (11) at random, and then poses the series of questions to the user; and

a transacting machine , such as an ATM ( 20), establishing a connection to the identifying computer (10), provides authorization to the valid and legal user to obtain cash, transfer money, etc.

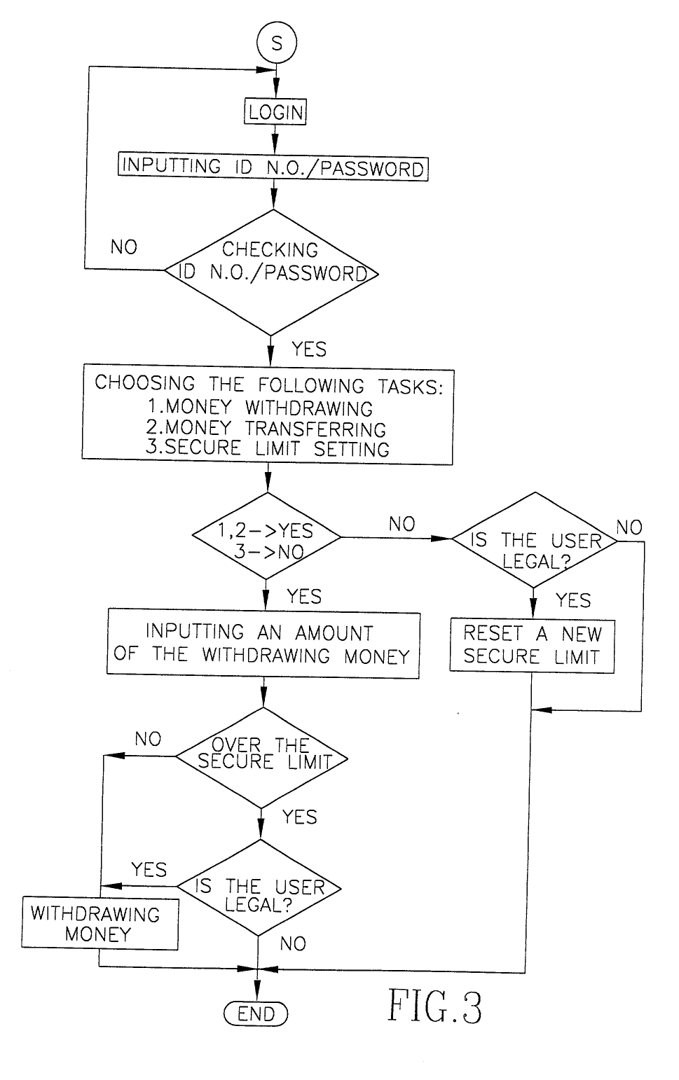

In reference to FIGS. 2 and 3, when a user utilizes the above transacting system, to start with, the user is able to input the ID number and the password for checking basic identity information. If the checking is without problem, the user is able to execute the next task offered by the ATM (20). If the user just would like to check the account content, the method is not executed. On other hand, if the user chooses the withdrawal from account task, the identifying computer (10) is executed.

Firstly, the identifying computer (10) offers the user a series of questions from the question server (11) and then examines the correctness of the answers. If the user passes the examining step, the user is allowed to execute the withdrawal from account task.

To avoid always executing the identifying computer (10) in the withdrawal or transfer of money tasks, the identifying computer offers a task to set up a checking secure limit for deciding whether the identifying computer is to be executed. That is, when the user inputs an amount of the money that is lower than the secure limit, the user is able to withdraw directly the money from ATM (20) without undergoing the identifying procedure. On the other hand, if the amount of the money is higher than the secure limit, then the identifying computer is executed, that is, the identifying computer runs the above the steps.

As per the above description, the method ensures the valid and legal identity of the user by posing the questions, and the user's private information is transferred via the questions by using a different transferred method. Therefore the solutions of the questions guarantee the privacy of the respective parties. Even if hackers steal the user's basic information from the connection, they have no idea on how to solve the questions, that is to say, the valid and legal user is able to have good protection while using a credit card and so on.

Although the present invention has been explained in relation to its preferred embodiment, it is to be understood that many other possible modifications and variations can be made without departing from the spirit and scope of the invention as hereinafter claimed.

What is claimed is

1. An intelligent identifying method for allowing access to a computer file, the method comprising the following steps:
obtaining a user's information being stored;
designing multiple question databases in accordance with the user's information by a means of transferring, and designing solutions corresponded to each question being stored in a solution database;
posing the user a series of questions selected from the question databases, and collecting answers from the user;
checking correctness of the answers in accordance with the solution database; and
examining identity of the user in accordance to the correctness of the answers.

2. The method as claimed in claim 1, wherein the private information comprises address, age, job, blood type, telephone number, birthday and a prior-consumption data of the user.

3. The method as claimed in claim 2, wherein the means of transferring is a direct transferring method that the user's information is designed directly to at least one direct question, whose solution is rested on the user's information.

4. The method as claimed in claim 2, wherein the means of transferring is an inferential method that the user's information is designed to at least one inferential question, whose solution is calculated by an eight diagram basis.

5. The method as claimed in claim 2, wherein the means of transferring is an inferential method that the user's information is designed to at least one inferential question, whose solution is calculated by an astrological basis.

6. The method as claimed in claim 2, wherein the means of transferring is a consuming method that the prior-consumption data is designed to at least one consumption question, whose solution is rested on the prior-consumption data of the user's information.

7. The method as claimed in claim 1, wherein the series of questions are classified into multiple posing types including “Multiple-choice”, “Yes Or No”, and “Dialog” types.
